(19) United States
(12) Patent Application Publication
(10) Pub. No.: US 2025/0065927 A1
(43) Pub. Date: Feb. 27, 2025

(54) METHOD OF TRANSFERRING A VEHICLE MODULE OVER AN INFRASTRUCTURE, INFRASTRUCTURE, VEHICLE MODULE AND USE THEREOF

(71) Applicant: Stichting Radboud Universiteit, Nijmegen (NL)

(72) Inventor: Nigel Edward HUSSEY, Nijmegen (NL)

(73) Assignee: Stichting Radboud Universiteit, Nijmegen (NL)

(21) Appl. No.: 18/723,790

(22) PCT Filed: Dec. 15, 2022
(86) PCT No.: PCT/NL2022/050720

§ 371 Date: Jun. 24, 2024

(30) Foreign Application Priority Data
Dec. 23, 2021 (NL) 2030252

(51) Int. Cl. B61B 13/08

(52) U.S. Cl. CPC B61B 13/08

(57) ABSTRACT

The present invention is in the field of a National Individual Floating Transportation Infrastructure (NIfTI) wherein floating vehicles can travel by magnetic levitation and propagation. The vehicles can travel at a controllable height above the existing, albeit modified, road infrastructure and at relatively high speeds.

### FIELD OF THE INVENTION

The present invention is in the field of a National Individual Floating Transport Infrastructure (NIfTI) wherein floating vehicles can travel by magnetic levitation and propagation. The vehicles can travel at a controllable height above the existing, albeit modified, road infrastructure and at relatively high speeds.

### BACKGROUND OF THE INVENTION

The present invention is in the field of individual transportation. Until now, cars based on the com-bustion engine have played an important role in transporting people. Recently, a transition towards partly or fully electrically driven cars has started, and further partly or fully self-driving vehicles are on their way to being developed. If a full transition towards electrically driven vehicles would take place, the energy demands on our power generation and distribution infrastructure would be enormous. Moreover, fa-talities and injuries due to road accidents have remained roughly constant over the past two decades and even with the gradual introduction of autonomous vehicles, the design of modern cars, coupled with their weight, means that any collision with such a vehicle will likely lead to serious injury or even death. Finally, congestion due to our current infrastructure and the sheer volume of traffic represents a major eco-nomic and productivity cost to both developed and developing economies. Unfortunately, this is unlikely to change with the advent of the electric car.

In the search for an alternative means of transportation of passengers and freight, the magnetic levitation concept has been developed. The concept relates to a system conceived for train transportation. It uses two sets of magnets, a first set to lift the train up, and a second set to move the ‘floating train’ ahead. Since the train is floating, friction is virtually absent and the train can move at great speed. An advantage of this technology is the absence of moving parts. However, the train still needs to travel along a guideway of magnets which control the train's stability and speed, and in view of safety, movement of the train is limited to a direction of propagation. The trains can move fast and acceleration and deceleration is also much faster than e.g. for other vehicles such as conventional trains; safety and comfort are still points of attention. The power needed for levitation is relatively small, whereas air resistance and drag, especially at lower speeds, consume most energy. This could be overcome by moving vehicles in a vacuum environ-ment. The construction of magnetic levitation systems is however relatively costly, though production and maintenance is cheaper, compared to high speed trains. Not many systems are in operation yet.

Some documents recite propagation of vehicles. JP 2002 238109 (A) recites a system for driving, propelling and controlling a small and lightweight car with a linear motor. Thereto magnetic coils for driving and propelling the car and permanent magnets are each provided at the ground side and at the vehicle side respectively. The coils are arranged in a linear state to the direction of movement, with each coil being wired in parallel with slip rails in a ladder state. U.S. Pat. No. 3,815,511 (A) recites a magnetic propulsion and levitation system for a vehicle which is adapted to travel over an established roadbed. The system includes one or more superconducting magnets carried by the vehicle and a plurality of coils embedded in the roadbed in the path of travel of the vehicle. The coils are sequentially energized at a predeter-mined position relative to the superconducting magnet for establishing levitation and propulsion forces. It is noted that superconducting magnets typically require cooling to low temperatures. WO 2001/066378 A1 recites a transport system with a pair of levitating rails, and each of the levitating rails has a core with a plurality of coils extending circumferentially around each of the cores. The coils are perpendicular to the lengths of the levitating rails. Each of the levitating rails has an upper surface directly above the core. A vehicle has wheels that roll on the upper surfaces of the levitating rails in a nonlevitating position. The vehicle has a plurality of magnets that create magnetic fields that pass through the coils while the vehicle is moving along the levitating rails. The magnetic fields induce current, which in turn causes an opposing magnetic field that levitates the vehicle. A steering rail having a plurality of coils is mounted to at least one of the guideways. Permanent steering magnets are located on each side of the steering rail to magnetically steer the vehicle along the guideways. WO 2019/143469 A1 recites a magnetic levitation system includes a guideway and a vehicle. The guideway has ferromagnetic yokes and induction coils. The vehicle has levitation magnets for magnetic interaction with the ferromagnetic yokes wherein the vehicle levitates relative to the guideway. The vehicle has stabilization magnets coupled thereto for electro-magnetic interaction with the induction coils as the vehicle travels along the guideway. Each stabilization magnet is a permanent magnet with a two-dimensional pattern of poles alternating in polarity in a first dimension and a second dimension. EP 3 354 512 A1 recites a magnetic suspension of a vehicle for an underpass with a ferromagnetic rail of an arbitrary cross section is proposed, which comprises permanent magnets and electromagnets mounted to be able to be attracted to a ferromagnetic rail. Permanent magnets are installed being arranged to control the force of attraction to the ferromagnetic rail. The position and/or mass of the permanent magnets can be adjusted before starting the movement under the weight of the vehicle and the transported load. Incidentally documents US 2010/236 445 A1, WO 2003/003389 A1, and US 2018/223481 A1, can be referred to.

The present invention relates to an improved floating vehicle and infrastructure, which overcomes one or more of the disadvantages with the above systems without jeopardizing functionality and advantages.

### SUMMARY OF THE INVENTION

The present invention relates in a first aspect to a method of transferring an individual vehicle module over an infrastructure (NIfTI). Contrary to the above MagLev systems, which use onboard magnets and reaction magnets, the present system has coils embedded in its tracks. An advantage thereof is that no batteries are required, such as Li batteries; it is noted that Li is a relatively scarce material. Furthermore, no energy needs to be stored (save for the onboard sensing, interfacing and lighting), and hence no energy for storing and retracting is needed, and no energy is lost during storing and retracting. As the present vehicles can be stripped of virtually all me-chanical and propagation components, their net weight is reduced to some 200-400 kg. As with MagLev systems, little friction is experienced during movement; however some magnetic drag may be present, which reaches a maximum at lower velocities (e.g. <10 m/sec). The present vehicle is a levitating vehicle with an on-board magnetic array and an off-board propulsion system that uses a series of pulses rather than a three-phase AC signal as used typically in linear motor devices. The arrangement of the magnet poles is also distinct. A sketch of NIFTI is given in FIG. 1a-b, which shows the pod at rest in the left panel and shows the principle of propulsion in the right panel. The present vehicle may comprise a carrier, such as a seat, or a wafer carrier. The exemplary vehicle in which the passengers are seated may have similar dimensions to a car. All seats may be pointed inwards. In the middle, a table may be provided. On this table a screen may be provided, on which the passengers can enter their destination or simply be entertained. The present vehicle is much lighter than (electric) cars and damage inflicted by collisions is therefore ex-pected to be much less grave; still the vehicle is preferably made of an impact-resistant material and energy/shock absorbing zones are preferably provided. The present vehicle is also much cheaper, as only a small set of components need to be provided therein.

Levitation of the vehicle is achieved by the z-component of the magnetic field induced by the coils. In addition to the present coils, at least some of the coils may comprise a core of a permanent magnet; these permanent magnets may provide a magnetic vertical force equal to 10-98% of the empty weight of the present vehicle, preferably 20-50%, such as 30-40%, therewith contrib-uting to the levitation force and reducing overall energy consumption in the coils without induc-ing forward motion. Initially, the magnet and hence the present vehicle module, lies flat on the track in which the coils are embedded, and some of the coils may be tilted with respect to the vertical. When the coils are energized, the vehicle will start to levitate at a certain height above the track, typically a few cm, and accelerate due to the horizontal gradients induced in the magnets. Stronger magnetic fields-created through additional coil windings and/or additional magnet inserts—may be installed on the end of each row of coils to make sure that the vehicle does not drift off the track itself. As the vehicle is moving, the coils only need to be energized for a short while during which the vehicle is forced forwards, and therefore can be pulsed. A response mechanism, provided by a controller, pulses the coils at the precise moment the pod is above them such that the vehicle maintains its speed. By placing the coils and permanent magnets strategically, the amount of current needed is found to be minimised. In order to further decrease the amount of energy required, conducting plates, e.g. aluminium plates, may be included as part of the tracks to allow the vehicle to glide over certain sections of road without the need for energized coils.

In the present method, an advanced infrastructure is provided. It is noted that said infrastructure may still largely coincide with an existing road infrastructure, e.g., in terms of routes, access to the infrastructure, tracks already provided, and so on. It is considered that especially when renovating existing infrastructure, the present infrastructure may be included in the existing infrastructure, at least partly. At least one individual track is provided, and typically a multitude of interconnected tracks may be provided. Each track comprises at least one series of coils, in particular a plurality of series of coils per track, wherein series of coils extend over the width of the track, so rows of coils are provided, each coil pointing upwards with or without a slight tilt. Therewith each series of coils is adapted to provide a levitational (vertical) magnetic force as well as a horizontal magnetic force. The horizontal magnetic force is directed along the length direction of the track. The centres of the coils are placed at distance from one another. In order to have active and inactive coils, at least one switch per series of coils is provided, and optionally at least one switch per coil, such that each individual coil can be energized. The switching technology may comprise transistors, such as MOSFETs. Each coil individually can be energized by an electrical current and de-energized. In order to keep the present vehicle on the track, and to prevent accidents, on at least one side of the track stronger magnetic fields may be provided, that is magnetic fields with a higher strength relative to a more central part of the track. The higher magnetic field strength may be provided by increasing the number of windings of the respective coils, such as 10-300% more windings, in particular 50-100% more windings. It is estimated that a force of up to 2400 N may be compensated as such, such as a force exerted by wind. Position location technology may also be provided on at least one side of the track. It is noted that the continuous motion of the vehicle overcomes Earnshaw's theorem, which states that a collection of point charges cannot be maintained in a stable stationary equilibrium configuration solely by the electrostatic interaction of the charges. When decelerating, the field gradient(s) may be reversed. When unexpected deceleration is required, such as in a case of an impending accident, the coils in the track will be energized with as large a current as possible. An additional braking mechanism may also be employed. Finally, an electrical power supply for providing an electrical current is present, which may be the grid, or a sub-grid.

The present vehicle is void of an engine, wheels, battery, suspension, steering wheel, etc. and has therefore a reduced weight, while maintenance thereof is very limited. The vehicle comprises an array of permanent magnets, preferably at a bottom side thereof. For the passengers, at least one seat is provided, or at least something for making a journey pleasant to a passenger. In view of the absence of an engine, much more space is available for passengers. The present module could therefore be relatively small. Typically more passengers could be present, and hence larger modules are considered, with e.g. 2-9 seats. In order for full control, the present vehicle module comprises an identifier, which may be used for controlling movement. As the passenger typically needs to identify a destination, a control interface may be present; however, existing infrastructure in this respect, such as smartphones, com-puters, the web, and so on may also be used.

When moving to a destination the present vehicle module is lifted, by providing a vertical component of the magnetic field and corresponding field gradient in the track at the location of the vehicle module. A horizontal component of the magnetic field is also provided, thereby ena-bling the module to be propelled at a certain speed in a horizontal direction over the track. Once the destination is reached, or in other occasions, the horizontal magnetic field is cancelled and/or an opposite magnetic field in the track may be provided, thereby decelerating the module and bringing the module to a stop. At the same time, the vertical magnetic field in the track may be cancelled, thereby letting the module down onto the track.

Advantages of the present invention are therefore an infrastructure with all the freedom of the car, but without the car itself, use of the existing road network, wherein the road becomes the engine, thereby removing most of the weight from the “vehicle”, wherein magnetic repulsion is used for both levitation and propulsion, and an optional on-board interface for receiving instruc-tions. The time spent in transit is entirely one's own. With sufficient attention, it is considered possible to achieve an energy consumption that is less than that of an electric car. With a mass<¼ that of an electric car and a streamlined shape, traffic mortalities are reduced, and since all traffic would be controlled by a central operating system, congestion may be prevented. The sense of ownership moves from the car to the infrastructure, and mobility for all people is provided, for any age, for any disability, and so on.

In a second aspect, the present invention relates to the above mentioned infrastructure, and in a third aspect to the above mentioned vehicle module.

In a further aspect the present invention relates to a series of coils for the present infrastructure, wherein, in the series of coils, coils are adjacent to one and another, and wherein each coil individually has an oblong shape with a width (w) and a length (l), in particular wherein the length is more than two times larger than the width, more in particular more than four times large than the width, such as 5-10 times as large as the width, wherein the length of each individual coil may be 10-100% of a width of the present infrastructure, wherein a height of each individual coil may be 1-25 cm, preferably 1.5-10 cm, such as 2-5 cm, wherein each coil individually may comprise a magnetic core or not, wherein each coil individually may comprise windings that are curved at one or more sides thereof.

Thereby the present invention provides a solution to one or more of the above mentioned problems.

Advantages of the present invention are detailed throughout the description.

### DETAILED DESCRIPTION OF THE INVENTION

The present invention relates in a first aspect to a method of transferring a vehicle module over an infrastructure according to claim 1. A preliminary study on boundary conditions for the present system is given in a BSc thesis of A. Kool, RU Nijmegen (Introducing a new mode of transport: NIfTI as an alternative to the electric car.), whose contents are incorporated by reference thereto. Further, more advanced studies were given in the theses of S. ten Napel, RU Nijmegen (Simulations of the magnetic field profiles for a magnet array associated with levitated transport) and K. Shirkoohi, University of Bristol (Simulating the analytical dynamics of the novel NIfTI magnetic levitation transport device).

In an exemplary embodiment of the present method in an inclined section of the track at least one series of coils is tilted over an angle α in a direction of the inclination, in particular wherein α is 0.5-2 times an inclination angle.

In an exemplary embodiment of the present method in a left or right curved section of the track at least one series of coils is tilted inwards over an angle β, in particular wherein β is 0-30 degrees with respect to a horizontal plane, more in particular wherein β is 2-15 degrees.

In an exemplary embodiment of the present method at a junction of tracks at least one series of coils comprises a magnetic insert, such as a magnetic core, wherein the magnetic insert is adapted to move in a direction perpendicular to a surface of the track, in particular through automation, thereby providing a positive or negative magnetic gradient in a direction of one of the tracks, in particular wherein the magnetic gradient is 50-200% relative to the levitational magnetic force.

In an exemplary embodiment of the present method on a straight part of the track, based on a location of the vehicle module, at least one controller is adapted to energize coils directly behind the vehicle module 10-50% more than the coils underneath the vehicle module, and/or at least one controller is adapted to energize coils directly in front of the vehicle module 1-10% less than coils underneath the vehicle module, relative to a direction of movement of the vehicle module.

In an exemplary embodiment of the present method, at least once, two series of coils may be interrupted by a metallic (i.e. an electrically conducting) plate, wherein the conducting plate extends in a longitudinal direction and width direction of the track.

In an exemplary embodiment of the present method, at least one permanent magnet is inserted into the bore of individual coils within a series of coils.

It has been found that therewith energy consumption can be reduced by more than 50%.

It is noted that at higher speeds, energy consumption may be reduced relative to lower speeds due to a reduction in (magnetic) drag and in the pulse duration within the coils.

In an exemplary embodiment of the present method, each series of coils may comprise each individually, at least one coil and/or part thereof which may or may not be slightly tilted, with respect to a vertical axis, (depending on whether the track includes an incline or not). On an incline, the coils may be tilted relative to the perpendicular (normal) to the surface of the track, such as tilted 0.5-40°, preferably 2-30°, more preferably 5-20°. Therewith both a horizontal and vertical magnetic force may be provided to the present vehicle module.

In an exemplary embodiment of the present method, coils, typically series of coils, each individually, may have their respective centres separated by a distance of 5-50 cm, such as 5-20 cm, which distance is typically in the direction of movement. The coils may be provided adjacent to one and another, with substantially no distance between them, or with a small distance between them, such as a distance of 0.2-10 cm.

In an exemplary embodiment of the present method, a track has a width of 0.6-3 m, such as 1.0-2.5 m, or a track has a width of 0.05-0.3 m, and a vehicle module has a width of 0.03-0.4 m, and a vehicle module has a length of 0.05-0.4 m, and an empty vehicle module has a weight of 0.05-2 kg, such as 0.1-0.5 kg, or a track has a width of 0.1-1.5 m, and a vehicle module has a width of 0.1-1 m, and a vehicle module has a length of 0.1-1 m, and an empty vehicle module has a weight of 4-50 kg, such as 10-25 kg. These tracks are therefore smaller then typically used tracks. As such more tracks per existing infrastructure may be provided. Part of the tracks may be especially adapted, being a bit broader, for the transport of goods, such as in intermodal containers of a width of slightly less than 2.5 m, especially on tracks for transport over long distances.

In an exemplary embodiment of the present method, a vehicle module has a width of 0.6-3 m, preferably 1-1.5 m.

In an exemplary embodiment of the present method, a vehicle module has a length of 0.6-3 m, preferably 1-1.5 m.

In an exemplary embodiment of the present method an empty vehicle module has a weight of 150-750 kg, such as 200-300 kg. The vehicle is relatively light, especially in comparison to existing vehicles, and are in fact comparable to the weight of motor cycles.

In an exemplary embodiment of the present method, at least two vehicle modules may be connectable. In view of transportation and limiting a number of movements such may be an advantage.

In an exemplary embodiment of the present method, a coil, each individually, may have a length 1-60 cm, preferably 2-40 cm, such as 10-30 cm. Such coils are found to provide sufficient magnetic forces.

In an exemplary embodiment of the present method, a coil, each individually, may have a radius of 1-20 cm, preferably 2-10 cm, more preferably 3-5 cm.

In an exemplary embodiment of the present method, the coil former, each individually, may have a thickness of 0.1-10 cm, preferably 0.2-5 cm, more preferably 1-3 cm.

In an exemplary embodiment of the present method, a coil, each individually, may have a number of windings nce [1,10000]/m, preferably 10-5000, more preferably 50-2500, such as 100-500.

In an exemplary embodiment of the present method, a coil, each individually, may comprise an electrically conducting material, such as a metal, such as copper or aluminium.

In an exemplary embodiment of the present method, a series of coils may be adapted to provide a magnetic field Bz of 10⁻³-10¹ [T], preferably 2*10⁻³-2 [T], more preferably 3*10³-10⁻¹ [T].

In an exemplary embodiment of the present method, over a width of a track 1-100/m coils in series may be provided.

In an exemplary embodiment of the present method, the respective centres of two series of coils may be separated by a distance of 5-20 cm.

In an exemplary embodiment of the present method, a magnet may comprise high magnetic density materials.

In an exemplary embodiment of the present method, a magnet may comprise at least one magnetic material selected from Group 3-12, Period 4-6 elements, such as Fe, Co, Ni, and Nd, and combinations thereof comprising such a magnetic material, such as Nd₂Fe₁₄B, FePd, FeCo, and FePt, and/or a material selected from lanthanoids, scandium, yttrium, and combinations thereof, such as from Sc, Y, Sm, Gd, Dy, Ho, Er, Yb, Tb, such as Tb.

In an exemplary embodiment of the present method, a magnet has a volumetric susceptibility of 10³-10⁶, such as 10³-3*10⁵.

In an exemplary embodiment of the present method, each coil individually may be adapted to receive a current of 0.5-200 [A], preferably 1-100 [A], such as 5-50 [A].

In an exemplary embodiment of the present method, a switch may be adapted to switch within 1000 usec, preferably within 100 usec.

In an exemplary embodiment of the present method, each coil may be adapted to be energized within 1-10⁵ μsec.

In an exemplary embodiment of the present method, each coil may be energized in a pulsed mode, such as in pulses of 1-100 msec, wherein preferably a length of a pulse is adapted to the speed of the vehicle module.

In an exemplary embodiment of the present method, the speed of the vehicle module may be from 0-150 m/sec, preferably from 0-75 m/sec, more preferably from 0-40 m/sec, such as 5-30 m/sec.

In an exemplary embodiment of the present method, the vehicle module may comprise an array of i∈[1,p] magnets with the same field orientation arranged in a strip-like manner, whereby strips of magnets (aligned in the direction of motion) are spatially separated in the direction perpendicular to the direction of motion. The strips are typically located parallel to a direction of movement, i.e. parallel to the track (see FIG. 3). An advantage of using a spatially separated strip arrangement for the magnets is that the total amount of magnet is reduced, thereby reducing the overall weight of the vehicle module, while at the same time, maximising the levitation force. The electrical current in a row of coils required to levitate and propel the module will accordingly be minimised.

In an exemplary embodiment of the present method, 10-100% of the bottom of the vehicles may be provided with magnets,

magnets have a height of 1-25 cm, preferably 1.5-10 cm, such as 2-5 cm. It is found that in view of forces the weight of magnets is preferably not too small.

In an exemplary embodiment of the present method, a length of all magnets may be 20-200 cm; preferably 40-120 cm, such as 45-100 cm, and there with a substantial part of the bottom of the vehicle may be provided with magnets.

In an exemplary embodiment of the present method, magnets may be provided above or below a bottom of the vehicle, preferably below a bottom.

In an exemplary embodiment of the present method, a total volume of magnets may be 0.1*10⁻³-50*10⁻³ m³.

In an exemplary embodiment of the present method, a magnetic moment may be 0.1-2000 Am², preferably 1-500 Am².

In an exemplary embodiment of the present method, coils may provide an acceleration/deceleration of 0.01-10 m/sec², preferably 0.2-5 m/sec². This relatively low acceleration will still bring vehicle modules up to a decent speed in a short period of time, and to high speeds in acceptable times as well.

In an exemplary embodiment of the present method, an additional braking mechanism may provide a deceleration of 1-20 m/sec², preferably 2-10 m/sec².

In an exemplary embodiment of the present method, the vehicle module may comprise a base with an array of i∈[1,p]*j∈[1,o] magnets with the same field orientation, such as arranged in a strip-like manner, whereby strips of magnets (aligned in the direction of motion) are spatially separated in the direction perpendicular to the direction of motion. The number of strips p will equal the number of coils in a single row (less the coils used to create the magnetic valley) and their width will be preferably 30-90% of the diameter of the coils, such as 40-70%, and o is preferably from 2-10³, such as 5-100.

In an exemplary embodiment of the present method, the controller may be adapted to control hovering of the vehicle module.

In an exemplary embodiment of the present method, a multitude of vehicle modules may be transferred, such as millions of vehicles. Clearly control of movement and operating tracks would involve lots of computing time, but nowadays that is not much of an issue.

In an exemplary embodiment of the present method, the infrastructure may be partly or fully incorporated into an existing infrastructure, wherein at least one track, each individually, is covered by a protecting layer, such as a 0.2-5 cm thick polymeric layer, preferably a recycled polymeric layer. For instance a bicycle path adjacent to the present track may be made entirely out of recycled plastic bottles, having a 30-40 year life span (c.f. 15 years for tarmac), and having virtually no CO₂ emissions. Similar thereto, there is no need for tarmac with NIfTI. Hence, such paths could be the surface covering for NIfTI too.

In an exemplary embodiment of the present method, the infrastructure may comprise a set of coils at the end(s) of each row with additional windings and magnet inserts thereby creating a magnetic ‘valley’ to prevent the vehicle module from leaving the track.

In an exemplary embodiment of the present method, the infrastructure may comprise position de-tection technology and if required, an additional magnetic braking system. In an exemplary embodiment of the present method, the vehicle module may be a monocoque, wherein the vehicle module preferably comprises at least one composite.

In an exemplary embodiment of the present method, a drag coefficient of the vehicle C_{D}<0.3, preferably C_{D}<0.2, such as 0.05<C_{D}<0.13, such as a droplet shaped vehicle. With the present vehicle modules much more freedom in design is obtained, as virtually no parts are present. Room for optimization in this (and other) aspects is therefore provided.

In an exemplary embodiment of the present method, the vertical magnetic field is applied to the centre of mass of the magnetic base, and/or wherein the horizontal magnetic field is applied to the same centre of mass.

In an exemplary embodiment of the present method, the vehicle module impact on collision may be minimized, for instance such that pedestrians would be deflected instead of hit square on.

In an exemplary embodiment of the present method, the track may be banked at an angle, preferably 0.1-30°, such as 1-10°, to enable a vehicle to navigate a curve in the track.

In an exemplary embodiment of the present method, at a junction of tracks, magnet inserts may be allowed to move vertically inside of the coils, through automation, to create an effective banking of the magnetic force lines and enable a vehicle to turn sharply left or right.

In an exemplary embodiment, the present infrastructure may comprise a hollow tube-like structure, such as under the road, wherein a surface of the tube-like structure comprises a polymeric material, such as a plastic, such as a recycled plastic, wherein the surface is preferably removable attached, wherein in the tube-like structure coil receiving elements are provided, such as a rack with coils. Therewith the present infrastructure can be operated with ease, is constructed in a low tech manner, and can be maintained well.

In an exemplary embodiment the present vehicle module may comprise an array of permanent magnets, preferably at a bottom side thereof, at least one seat, preferably 2-9 seats, such as 3-4 seats, an identifier, and an optional control interface.

The present vehicle module and infrastructure may be used in the present method.

The invention is further detailed by the accompanying figures and examples, which are exemplary and explanatory of nature and are not limiting the scope of the invention. To the person skilled in the art it may be clear that many variants, being obvious or not, may be conceivable falling within the scope of protection, defined by the present claims. In addition reference is made to an article submitted for publication by K. Shirkoohi and N. E. Hussey, which article and its contents are incorporated by reference.

### SUMMARY OF FIGURES

FIGS. 1a,b, 2-4, 5a-c, and 6-14 show details of the present invention.

### DETAILED DESCRIPTION OF FIGURES

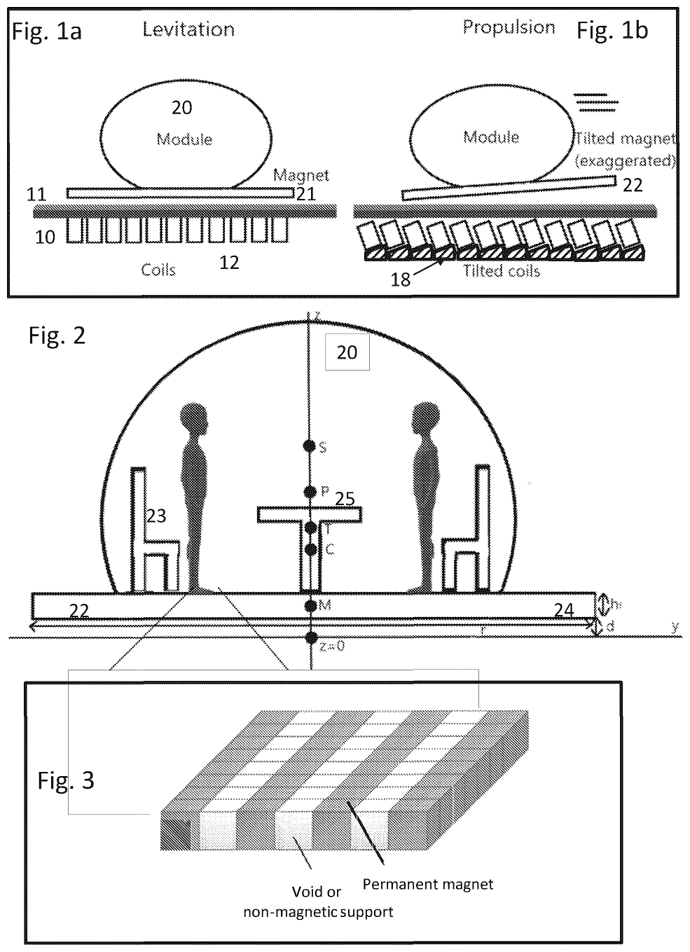

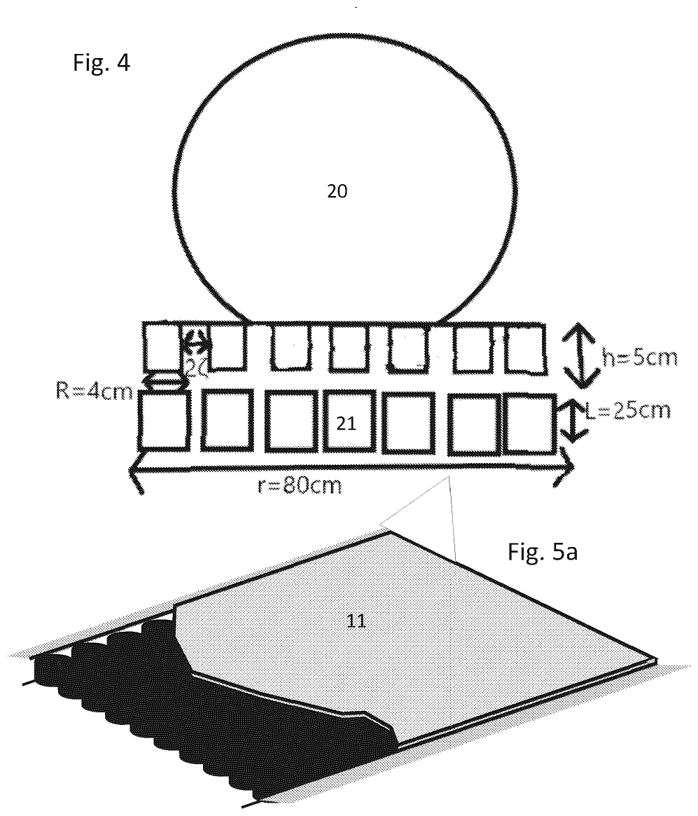

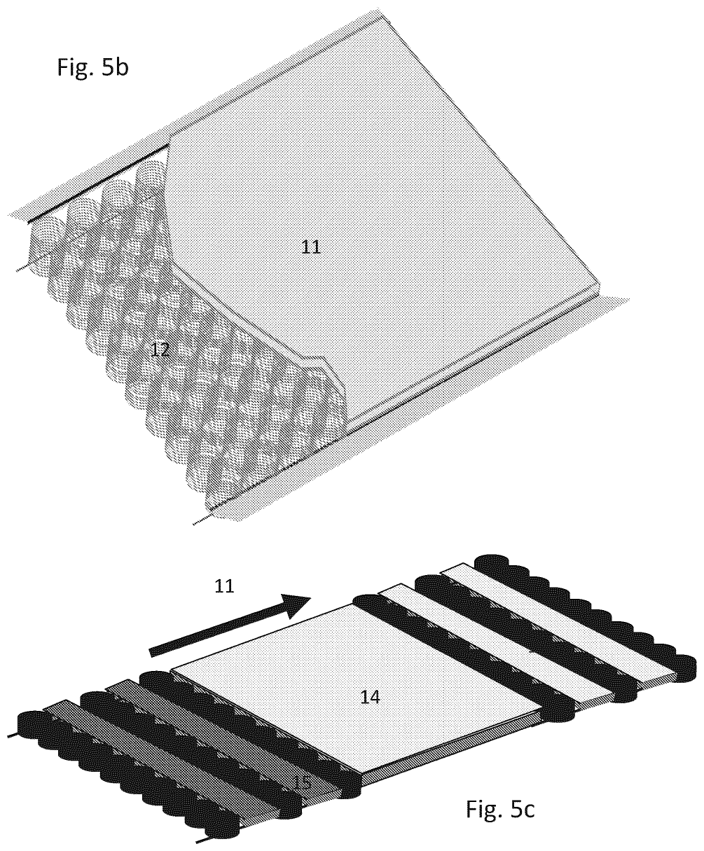

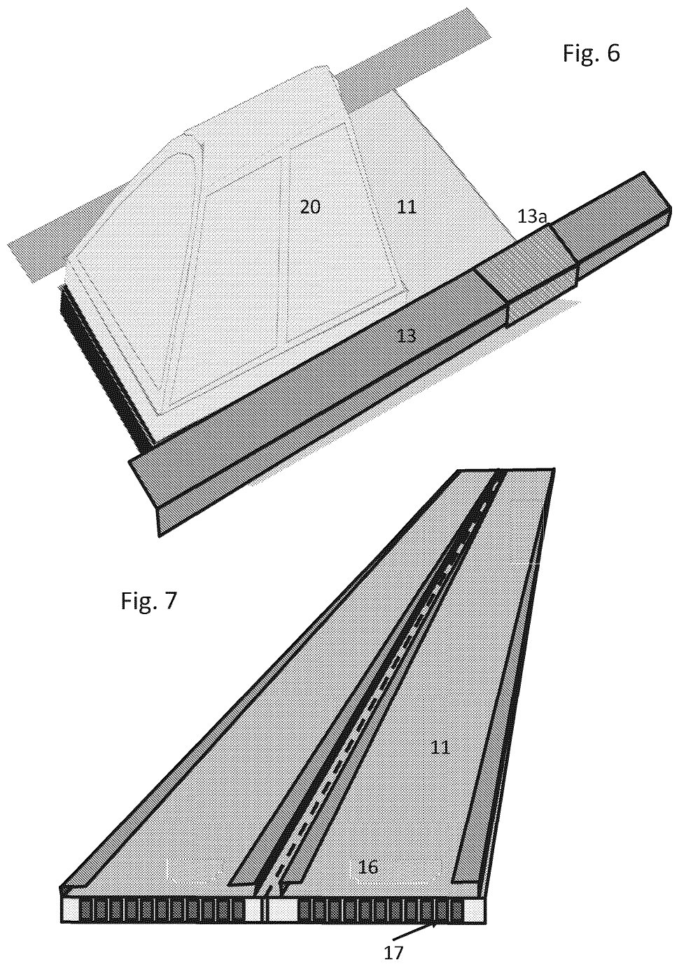

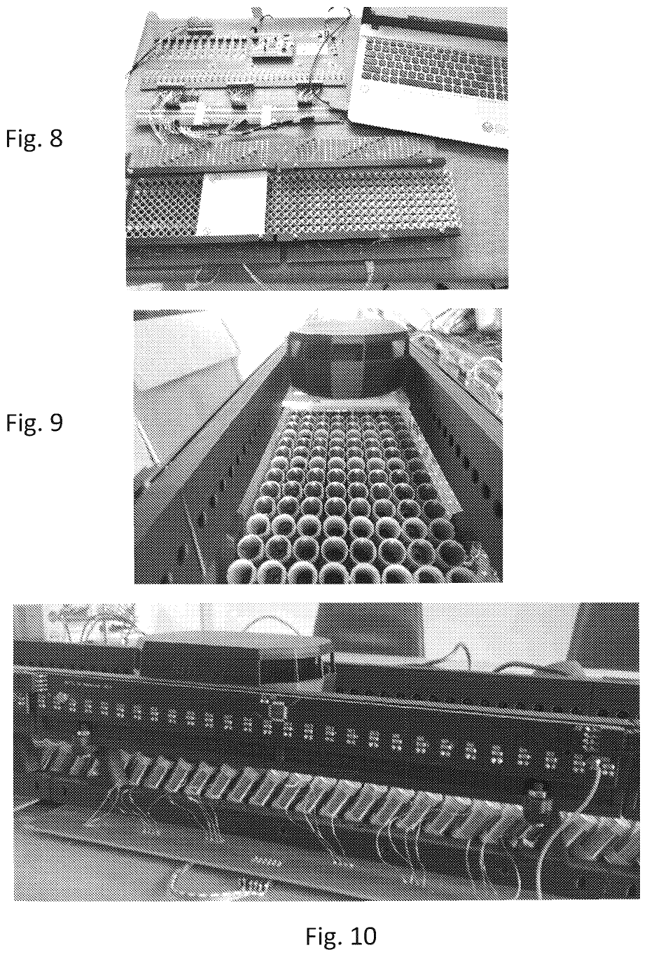

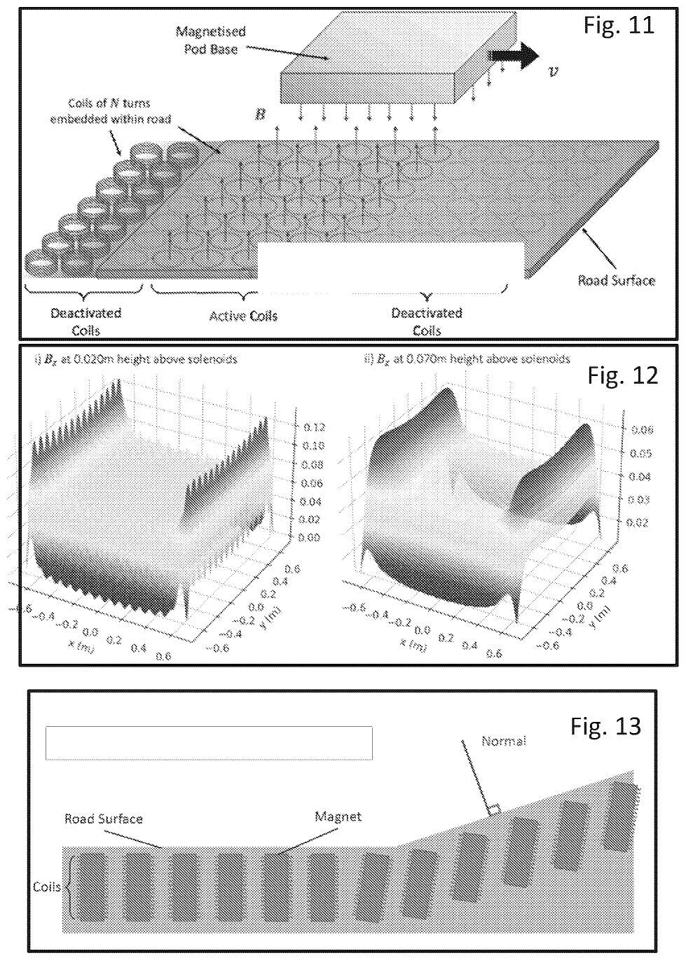

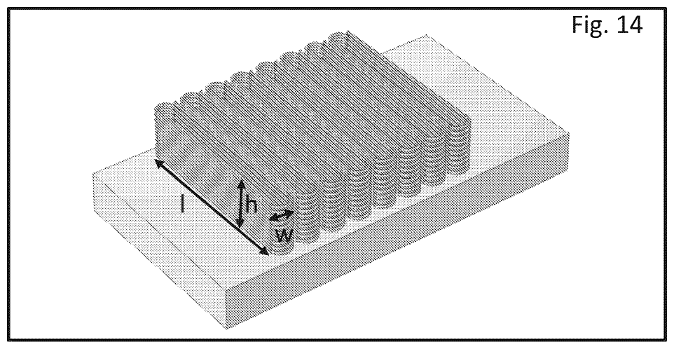

FIG. 1: A raw sketch of a first version of NIfTI. The left panel 1a shows the vehicle 20 at rest comprising magnets 21 in a bottom side 22 thereof, levitating above its track 11 with coils 12. The right panel 1b shows the vehicle moving to the left, with a general sketch of the propulsion system. A rack 18 is provided for receiving the coils in a tilted position.

FIG. 2: A sketch of the cross section of the pod 20. In the middle is the table 25, on the sides there are two passengers. For clarity of the sketch, persons 2 and 4 are not included. In the picture, M is the centre of mass of the magnet, T is the centre of mass of the table, P is the net centre of mass of the people, C is the net centre of mass of the chairs and S is the centre of mass of the pod itself. The point z=0 is at the top of the coils, hr below the middle of the magnet. A typical mass of a vehicle, including four passengers is calculated to be some 500-600 kg. Seats 23, bottom 22, and identifier 24 are also indicated.

FIG. 3 shows an enlargement of a part of the magnet array 21 provided in the vehicle module, with its spatial arrangement of magnetic strips.

FIG. 4: A sketch of the vehicle 20 with a base of magnetic strips instead of an entire magnet. This view can be seen as a front of behind view on the pod, since the strips are in the direction of motion.

FIGS. 5a-b show a part of track 11 with series of coils 12 provided underneath the track. FIG. 5c further shows conducting plate 14, and permanent magnets 15 provided in the track.

FIG. 6 shows an artist impression of the present vehicle module 20 moving over track 11, with guiders 13 provided at sides thereof, which guiders are sub-divided in sections 13a.

FIG. 7 shows an artist impression of the present track 11, projected over a bicycle lane, with hollow tube 17 and protective layer 16.

FIG. 8 shows a section of track of the current prototype with a magnetic array sitting on top as well as some of the control electronics.

FIG. 9 shows an end-on view of the completed track with the NIfTI module floating above the array of coils.

FIG. 10 shows a side view of the prototype highlighting the tilted coil arrangement and the LED position detectors.

FIG. 11: Diagram showing the function of the ‘pulsed’ coils which propel the pod. The active coils are at least the length of two coils behind the front of the pod, and at least two coils behind the pod. This creates a strong magnetic field gradient in Bz which causes the pod to propel forward. A similar mechanism is used in order to brake the motion of the pod.

FIG. 12: Surface plots relative to position above the surface of 16×16 array of solenoids (Scale B). Magnets at the centre of the track have a radius of 0.035 m. The two rows in y at the either edge of the track have a radius of 0.050 m, hence produce a strong magnetic valley. At low heights, the gradient in Bz is large hence the restoring force of the valley is effective.

FIG. 13 shows a schematic example of tilting coils over an angle α at an inclined section of a track.

FIG. 14 shows an example of oblong coils.

The figures are further detailed in the description.

### EXAMPLES/EXPERIMENTS

The invention although described in detailed explanatory context may be best understood in conjunction with the accompanying examples of present small-scale prototypes and figures as detailed above.

For the prototype, 123 rows of coils, each consisting of 8 coils wired in series, is used. The arrangements of the magnets in the base of the pod comprise a Halbach array, such in which the magnetic field polarity flips 90 degrees with each next magnet going from left to right. This means that for every 2 magnets the direction of the magnetic field is inverted. A width of each coil is twice that of one magnet cube, in order to ensure that they always have an opposing polarity with the magnet exactly above it. This is done by having the direction of the current running through the coils flip from one coil to the next.

The coils used in this prototype have an outer diameter of 10.7 mm, an inner diameter of 9 mm and a height of 26.3 mm. The wire for the coils has a diameter of 0.25 mm. The coils each have 100 turns. The distance between the center of two coils is 12 mm.

Six pieces of track were joined together to house 128 rows of coils all of which are tilted 30° with respect to the vertical. Each row has 8 pins that are used to keep the coils steady and in place. In two of the 8 coils in each row, a small disc-shaped magnet is inserted in the bottom to provide additional levitation force. Finally, for each part of the track a guiding rail is also added, housing LED position detectors.

The electronic control board is designed such that it can power any row individually. In total 144 coil rows can be connected to the control board.

More details on this first NIfTI prototype can be found in the MSc theses of T. van Wolfswinkel, RU Nijmegen (The Development and testing of NIfTI prototype Mk.V).

Returning to a full-scale infrastructure, some exemplary qualifications and quantifications are given below.
1. The mass of the entire vehicle with passengers is about 600 kg, and without passengers it is about 250-300 kg. This is much less mass than an electric car. The transport module optimally has the form of a flat-tened sphere or of an ellipsoid.
2. The magnet is a square plate magnet with height 0.03 m and sides 1.0 m divided into 10 strips of width 0.06 m. The mass of the magnet is 160 kg. For the purposes of calculating the magnetic force necessary for levitation, only the centre of mass of the magnet array is required.
3. With these parameters, the necessary current turns out to be between 10 A and 30 A. This is the most important parameter for determining the total energy consumption. 4. The diameter of the coils is 10 cm, their height is 25 cm and they have 125 windings. The wire is made of copper with resistivity ρ=2·10⁻⁸ Ωm and diameter of 2 mm. There are a total of 10 coils in each series.
5. The effective magnetization of the magnet is μ₀M=2 T.
6. The density is ρ=5000 kg/m³.

To compare NIfTI with an electric car, motion along a track of 10 km is discussed. An electric car uses about 34 kWh per 100 miles, which is about 7.606·10⁶J per 10 km. It is assumed that the entirety of the 10 km track contains rows of coils. There are then 10⁴/d rows of coils. I=20 A, N=125, ρ=2·10⁻⁸ Ωm and d=0.1 m. The typical diameter of a copper wire is r=1 mm. It remains to determine Δt. Assuming the pod moves at a velocity of 16 m/s results in Δt=0.06 s. When part of the track is void of coils, such as 20-60% thereof, and small permanent magnets are inserted into the cores of all or some of the coils, an according reduction of energy use is obtained (factor of 1.5-5, such as 2). An energy consumption would then be about 50-100% of that of an electric car. In addition, costs of operation, including maintenance, depreciation, and so one, are a factor lower as well; in an estimate a factor 3 lower.

In conclusion the present system of human transport is a self-driving module which is propelled by a system of coils interacting with an on-board magnet. The vehicle can run on 10-30 A and can reach the usual velocities of a car. Furthermore, it possesses some major benefits with respect to either traditional cars or electric cars. It uses about 50-100% of the energy of an electric car and costs about 30% of the amount of money that goes into an electric car. Furthermore, it provides environmental and ethical benefits with respect to the traditional ways of human transport.

1. A method of transferring a vehicle module over an infrastructure, comprising
providing said infrastructure, wherein the infrastructure comprises
at least one individual track,
wherein each track comprises at least one series of coils, wherein series of coils extend in the direction of the width of the track, wherein each series of coils is adapted to provide a levitational magnetic force wherein coils are placed at a distance from one another, at least one switch per series of coils, wherein each coil individually can be energized by an electrical current and de-energized, wherein each coil is adapted to be energized in a pulsed mode, wherein on at least one side of the track side coils are provided adapted to provide a larger magnetic field than central coils at a central part of the track,
at least one controller for energizing individual coils such that at a side of the track a larger magnetic field is provided than at a central part of the track,
an electrical power supply for providing an electrical current,
providing said vehicle module, wherein said vehicle module comprises an array of permanent magnets, at a bottom side thereof,
providing a vertical magnetic field in the track at a location of the vehicle module, thereby lifting the module,
providing a horizontal magnetic field in the track at a changing location of the vehicle module, thereby hovering the module at a certain speed in a horizontal direction over the track,
providing an opposite magnetic field in the track controlling the horizontal magnetic field, thereby decelerating the module, and
cancelling the vertical magnetic field in the track thereby letting the module down to the track.

2. The method according to claim 1, wherein in an inclined section of the track at least one series of coils is tilted over an angle α in a direction of the inclination.

3. The method according to claim 1, wherein in a left or right curved section of the track at least one series of coils is tilted inwards over an angle β.

4. The method according to claim 1, wherein at a junction of tracks at least one series of coils comprises a magnetic insert, wherein the magnetic insert is adapted to move in a direction perpendicular to a surface of the track, thereby providing a positive or negative magnetic gradient in a direction of one of the tracks, wherein the magnetic gradient is 50-200% relative to the levitational magnetic force.

5. The method according to claim 1, wherein on a straight part of the track, based on a location of the vehicle module, at least one controller is adapted to energize coils directly behind the vehicle module 10-50% more than the coils underneath the vehicle module, and
at least one controller is adapted to energize coils directly in front of the vehicle module 1-10% less than coils underneath the vehicle module,
relative to a direction of movement of the vehicle module.

6. The method according to claim 1, wherein at least once two series of coils are interrupted by at least one of an electrically conducting plate and permanent magnet plate, wherein the plate extends in a longitudinal direction and width direction of the track, and
wherein each series of coils is located below a surface of the track, and wherein at least one coil and part thereof may or may not be tilted with respect to a perpendicular of the surface of the track.

7. The method according to claim 1, comprising an element selected from
a series of coils whose respective centres are separated by a mutual distance of 1-50 cm,
a track which has a width of 0.6-3 m, and a vehicle module which has a width of 0.6-3 m, and a vehicle module which has a length of 0.6-3 m, and an empty vehicle module which has a weight of 150-750 kg, and from
a track which has a width of 0.05-0.3 m, and a vehicle module which has a width of 0.03-0.4 m, and a vehicle module which has a length of 0.05-0.4 m, and an empty vehicle module which has a weight of 0.05-2 kg, and from
a track which has a width of 0.1-1.5 m, and a vehicle module which has a width of 0.1-1 m, and a vehicle module which has a length of 0.1-1 m, and an empty vehicle module which has a weight of 4-50 kg,
at least two vehicle modules which are connectable,
a coil, each individually, which has a length 1-60 cm,
a coil, each individually, has a radius of 1-20 cm,
a coil, each individually, has a thickness of 0.1-10 cm,
a coil, each individually, has a number of windings n_{c}∈[1,10000]/m,
a coil, each individually, comprises an electrically conducting material,
a series of coils is adapted to provide a magnetic field Bz of 10⁻³-10¹ [T],
over a width of a track 1-100/m coils in series are provided,
two series of coils are separated by a respective centre distance of 1-20 cm,
a magnet comprises high magnetic density materials,
a magnet comprises at least one magnetic material selected from Group 3-12, Period 4-6 elements,
each coil individually is adapted to receive a current of 0.5-200 [A], wherein a switch is adapted to switch within 1000 μsec,
at least one switch per individual coil or per row of coils, and wherein each coil is adapted to be energized within 1-10⁵ μsec.

8. The method according to claim 1, wherein each coil is energized in pulses with a duration of 1-100 msec, and wherein a length of a pulse is adapted to the speed of the vehicle module.

9. The method according to claim 1, wherein the speed of the vehicle module is from 0-150 m/sec.

10. The method according to claim 1, wherein at least one of the vehicle module comprises an array of i∈[1,p] magnets with the same field orientation,
50-100% of the bottom of the vehicle is provided with magnets,
magnets have a height of 1-25 cm,
a length of all magnets is 20-200 cm;
wherein magnets are provided above or below the bottom of the vehicle,
wherein a total volume of magnets is 0.1*10⁻³-100*10⁻³ m³, wherein a magnetic moment is 0.1-2000 Am²,
wherein coils provide an acceleration/deceleration of 0.01-10 m/sec², and
wherein an additional braking mechanism provides a deceleration of 1-20 m/sec².

11. The method according to claim 1, wherein vehicle module comprises a base with magnetic strips, wherein a number of magnetic strips p is equal to a number of coils in a single row and the coil width is 30-90% of a respective diameter of the coil, and
wherein a magnet has a volumetric susceptibility of 10³-10⁶.

12. The method according to claim 1, wherein the controller is adapted to control hovering and propagation of the vehicle module, and/or wherein a multitude of vehicle modules is transferred, and
wherein the infrastructure is partly or fully incorporated in an existing infrastructure, wherein at least one track, each individually, is covered by a protecting layer.

13. The method according to claim 1, wherein the infrastructure comprises physical and controllable guiders, and guidance coils, wherein guidance coils are oriented accordingly.

14. The method according to claim 1, wherein the vehicle module is a monocoque, wherein the vehicle module comprises at least one composite, and
wherein a drag coefficient of the vehicle C_{D}<0.3, and
wherein a vehicle module impact on collision is minimized.

15. An infrastructure for a method according to claim 1, comprising
at least one individual track, wherein each track comprises at least one series of coils, wherein series of coils extend in the direction of the width of the track, wherein each series of coils is adapted to provide a levitational magnetic force and a horizontal magnetic force, wherein the horizontal magnetic force is directed along the length direction of the track, wherein coils are placed at a distance from one another, at least one switch per series of coils, wherein each coil individually can be energized by an electrical current and de-energized, wherein on at least one side of the track side coils are provided adapted to provide a larger magnetic field then central coils at a central part of the track,
a controller for energizing individual coils such that at a side of the track a larger magnetic field is provided than at a central part of the track,
a vehicle module track-position locator, and
an electrical power supply for providing an electrical current.

16. The infrastructure according to claim 15, selected from an indoor infrastructure, a logistics infrastructure, a toy race track, a toy train track, a wafer transporter, an outdoor infrastructure, wherein in an inclined section of the track at least one series of coils is tilted over an angle α in a direction of the inclination.

17. The infrastructure according to claim 15, comprising a hollow tube-like structure under the road, wherein a surface of the tube-like structure comprises a polymeric material, wherein the surface is removable attached, wherein in the tube-like structure coil receiving elements are provided.

18. A vehicle module for a method according to claim 1 wherein said vehicle module comprises an array of permanent magnets, at least one seat, an identifier, and control interface.

19.-20. (canceled)

21. A series of coils for the infrastructure of claim 15, wherein, in the series of coils, coils are adjacent to one and another, and wherein each coil individually has an oblong shape with a width and a length, wherein the length is more than two times larger than the width.

22. A method of transferring a vehicle module over an infrastructure according to claim 1, wherein the infrastructure comprises
a multitude of interconnected tracks, and wherein each track comprises a plurality of series of coils.
